(19) United States
(12) Patent Application Publication
(10) Pub. No.: US 2005/0038744 A1
(43) Pub. Date: Feb. 17, 2005

(54) Method and system for operating a banking service

(76) Inventor: Niel Eben Viijoen, Stellenbosch (ZA)

Correspondence Address: LAHIVE & COCKFIELD, LLP., 28 STATE STREET, BOSTON, MA, 02109, US

(21) Appl. No.: 10/497,473

(22) PCT Filed:
(86) PCT No.: PCT/IB02/04986

(30) Foreign Application Priority Data
Nov. 29, 2001 (ZA) 2001/9840

(51) Int. Cl. G06F 17/60

(52) U.S. Cl. 705/42; 705/43

(57) ABSTRACT

A method and system for operating a banking service are included. The system includes a database (12) for storing client registration data and a unique number, which is preferably the MSISDN or mobile telephone number of the client. This number is used as the client's account number. A call center (14) receives calls from clients and verifies their identity from data transmitted by their mobile telephones. The system allows clients to conduct various banking transactions including balance, statement and payment transactions. A database stores details of balances and/or transactions in each user's account. The system serves for clients to be notified by an SMS transmitted to their mobile telephone of transactions, such as changes to their bank balances or the crediting or debiting of their account. The system can also interface with conventional banking services.

### BACKGROUND OF THE INVENTION

THIS invention relates to a method of and a system for operating a banking service.

For a number of reasons, including issues of cost, convenience and security, clients of banks increasingly are tending to make use of electronic banking services which do not, require the physical presence of the client at a bank or even an ATM.

With the increasing acceptance of cellular telephones, it has been proposed to use such telephones as terminals from which a client can access his/her bank account and carry out at least some banking functions. Existing proposals, however, have tended to be somewhat cumbersome and inconvenient in operation.

It is an object of the invention to provide an alternative method of operating a banking service utilising mobile terminals such as mobile telephones.

### SUMMARY OF THE INVENTION

According to the invention there is provided a method of operating a banking service, the method comprising:
registering a plurality of clients with the banking service, including recording a unique number associated with a mobile telephone of each client;
allocating an account number to each client which comprises at least a part of said unique number;
receiving, from time to time, calls from a client via the client's mobile telephone;
verifying the client's identity from data transmitted from the mobile telephone corresponding to said unique number; and
conducting at least one banking transaction relating to the account corresponding to said unique number.

Preferably, the account number allocated to each client corresponds to the unique network number of the client's mobile telephone.

The account number preferably corresponds exactly to the Mobile Station Integrated Services Digital Network (MSISDN) number of the mobile telephone.

The method may comprise providing an Interactive Voice Response (IVR) interface responsive to selective data transmissions from the mobile telephone to select and configure at least one of a plurality of banking service options.

The plurality of banking service options may comprise a bank balance service, a bank statement'service, and a payment service.

The bank balance service may comprise transmitting bank balance data to the client at intervals specified previously by the client, or on request.

The bank balance data may be transmitted in SMS format to the mobile telephone of the client.

Alternatively, or in addition, the bank balance data may be transmitted to the mobile telephone of the client in an audible format.

The bank statement service may comprise transmitting statement data to a facsimile number stipulated by the client in a request made by the client to the IVR interface.

The payment service may comprise the steps of receiving a payment. instruction from a payer who is a registered client of the banking service, the payment request comprising the amount to be paid and a unique network number of a mobile telephone of the payee, and transferring funds from the payer's account to the payee's account.

Preferably, both the payer and the payee are registered clients of the banking service, each having an account number which corresponds exactly to the unique MSISDN number of their respective mobile telephones.

In an enhancement of the invention, the payment service may comprise the steps of recording at least one account number of an external account held with a conventional banking service, and receiving an instruction from a registered client of the banking service to transfer funds to or from said external accounts, from or to the registered client's account.

The method may include transmitting payment confirmation data, preferably in SMS format, to the mobile telephones of the payer and the payee.

The invention extends to a system for operating a banking service, the system comprising:
a database for storing client registration data of a plurality of clients including a unique number associated with a mobile telephone of each client and a bank account number which comprises at least a part of said unique number;
a call center for receiving calls from clients via their mobile telephones, for verifying a client's identity from data transmitted from the client's mobile telephone corresponding to said unique number, and for enabling the conducting of at least one banking transaction relating to the account corresponding to said unique number; and
a bank account database for storing details of balances and transactions in each client's account.

The account number allocated to each client preferably corresponds to the unique network number of the client's mobile telephone.

The account number preferably corresponds exactly to the Mobile Station Integrated Services Digital Network (MSISDN) number of the mobile telephone.

The call center may be an Interactive Voice Response (IVR) interface responsive to selective data transmissions from the mobile telephone to select and configure at least one of a plurality of banking service options.

The system may include a Short Message Service Center (SMS-C) arranged to serve as a gateway between the mobile telephones of clients and the system and to transmit bank balance data and payment confirmation data from the system to the mobile telephones of clients.

The bank account database is preferably a secure database operated by a value added service provider in conjunction with a cellular network operator.

### BRIEF DESCRIPTION OF THE DRAWINGS

FIG. 1 is a schematic diagram illustrating a system for operating a banking service according to the invention;

FIG. 2 is a simplified flow diagram illustrating the main service options offered to clients by the prototype system of the invention; and

FIGS. 3 to 7 are flow diagrams illustrating major steps in implementing the service options shown in FIG. 2.

### DESCRIPTION OF AN EMBODIMENT

The method and system of the invention are designed to provide a banking service that is independent of existing banks and that offers service options which can be accessed by clients using their mobile telephones. Since it is not necessary in the system of the invention to link a database of clients to other, independent databases of third party banks or the like, a relatively compact and efficient structure is possible, in which a client can use his/her mobile telephone number as a bank account number.

The Mobile Station Integrated Services Digital Network (MSISDN) number allocated to each mobile telephone in a country is unique and can therefore be used as a unique bank account number in the system of the invention. The Caller Line Identification (CLI) technology used by cellular network operators identifies each mobile telephone from which a call originates, and the corresponding identification data can be used by the system of the invention to identify a client contacting the banking service and to identify his/her account number without any further data input being required from the client. A PIN or password-based identity verification system is preferably used to ensure that the person utilising the mobile telephone is, in fact, the client.

Once the client has contacted the banking service's call center, an Integrated Voice Response (IVR) system assists the client to select various banking service options. The client need only enter data via the numeric keypad of the mobile telephone in order to select the required options and to enter any monetary amount or recipient account number in the case of payment/transfer transactions. The accounts to which payments can be made must be accounts operated by the banking service of the invention, so that they can be identified by the mobile telephone numbers of the respective account holders (see below.) This means that a first client of the banking service can effect a payment to a second client of the banking service by knowing nothing more than the mobile telephone number of the second client.

The operation of the method and system of the invention are now described below in greater detail.

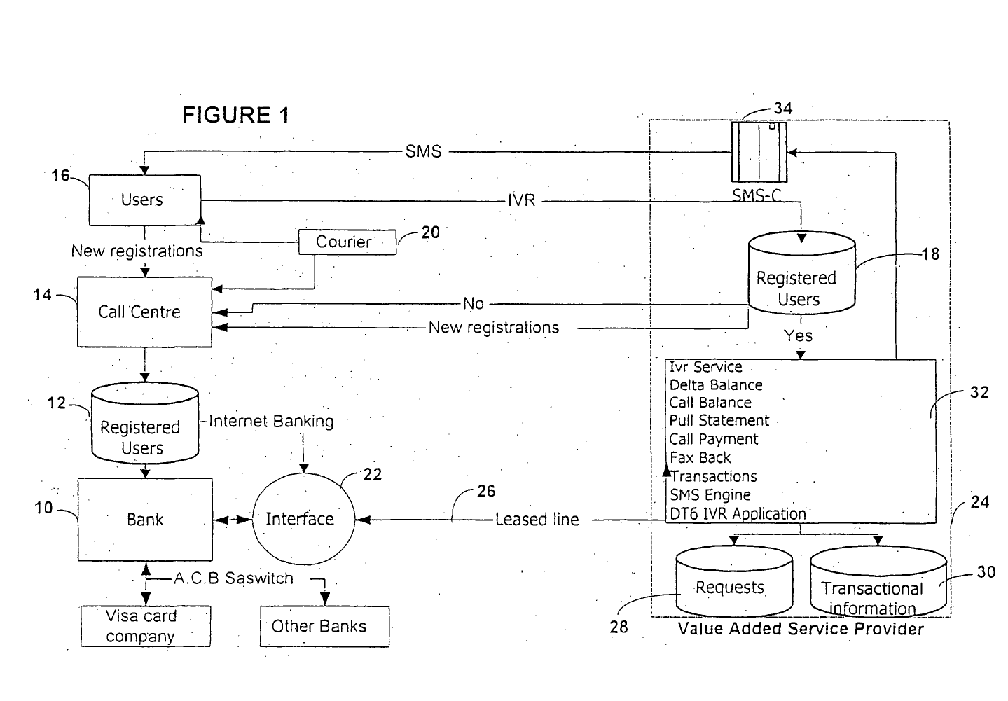

FIG. 1 shows, in simplified block diagrammatic form, the prototype system for operating a banking service according to the invention. The heart of the system is a bank 10 which is a clearing bank as defined in the SA Banking Act. A database 12 stores details of registered users or clients of the bank and communicates with a call centre 14. The tall centre provides both human operators and an Integrated Voice Response (IVR) facility for users (clients) 16 who call into the call centre and, depending on the circumstances, may register as a new client or may interact with the IVR system to carry out one of a number of predetermined functions. In the latter case, where a registered user (registered client) utilises the IVR function, the client's enquiry is referred to a database 18 of registered users (registered clients) so that the identity of the client can be established.

A courier service 20 is utilised to distribute new user cards and PIN codes to clients registered for the first time with the system.

Via an interface 22 which provides a secure facility for conducting banking transactions based on a verified instruction or trigger, the bank 10 receives communications from a value added service provider 24 via a secure data line 26. The value added service provider includes secure databases 28 and 30 which store data relating to banking transactions. One or more secure servers run the software applications 32 by means of which the various functions of the system are implemented. Finally, the value added service provider 24 includes a Short Message Service Centre (SMS-C) 34 which is part of the cellular or other mobile network which supports the system of the invention and which serves as a gateway for all SMS traffic in the system.

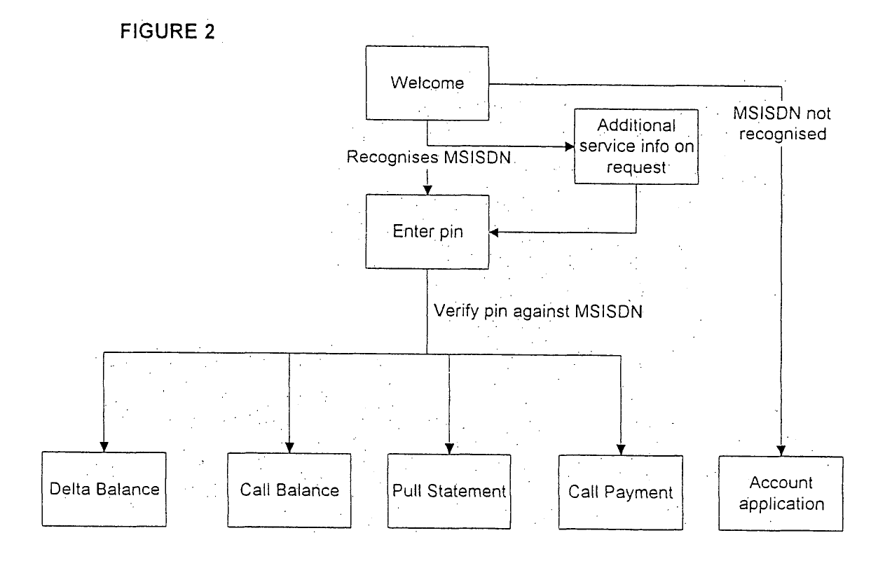

FIG. 2 illustrates the basic process followed by a client accessing the call center of FIG. 1.

A client contacting the call center receives a welcome message generated by the IVR system. Assuming that the client is registered with the banking service, the MSISDN number of the client's mobile telephone will be recognised and the client will be prompted to enter a PIN via the keypad of the mobile telephone. The PIN is checked against the database record corresponding to the account number/MSISDN of that client, and if verification is successful, the client is then offered four options, identified in FIG. 2 as “DELTA BALANCE”, “CALL BALANCE”, “PULL STATEMENT”, and “CALL PAYMENT”. The operation of each of these options is described in greater detail below.

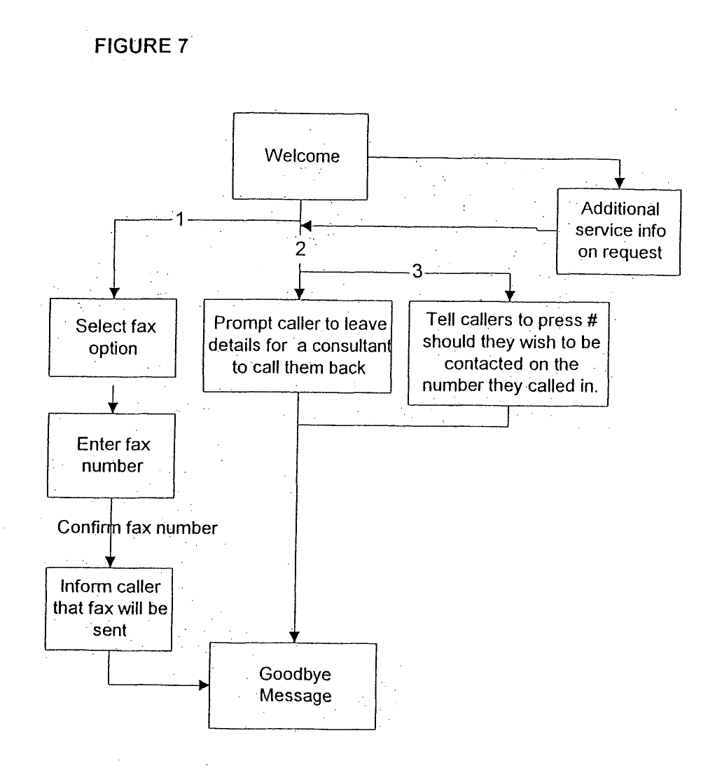

In the event that the MSISDN of the client's mobile telephone is not recognised, the client is routed to an “Account Application” routine which is described below with reference to FIG. 7.

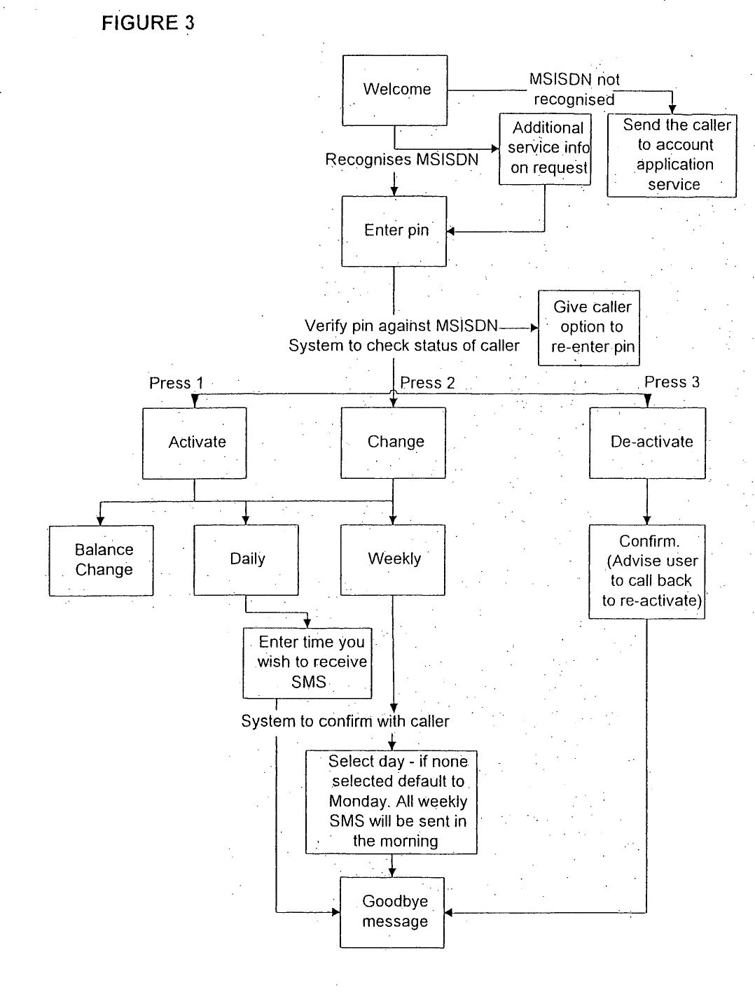

The operation of the Delta Balance service is illustrated in the flow chart of FIG. 3.

This service allows the client to have his/her bank balance delivered as an SMS. Clients can set up profiles to receive their balances as they require. The following options are available:
Every time the balance changes (hence “delta” balance)
Daily
Weekly

For daily options the client is able to specify the time that they would like to receive their SMS. Clients contacting the call centre are given the option to activate, deactivate or change the service. The message content includes details of the last transaction as well as the balance.

This service is a “push”. Once the client has set up a profile, the information will be sent as required until they call in again to deactivate themselves.

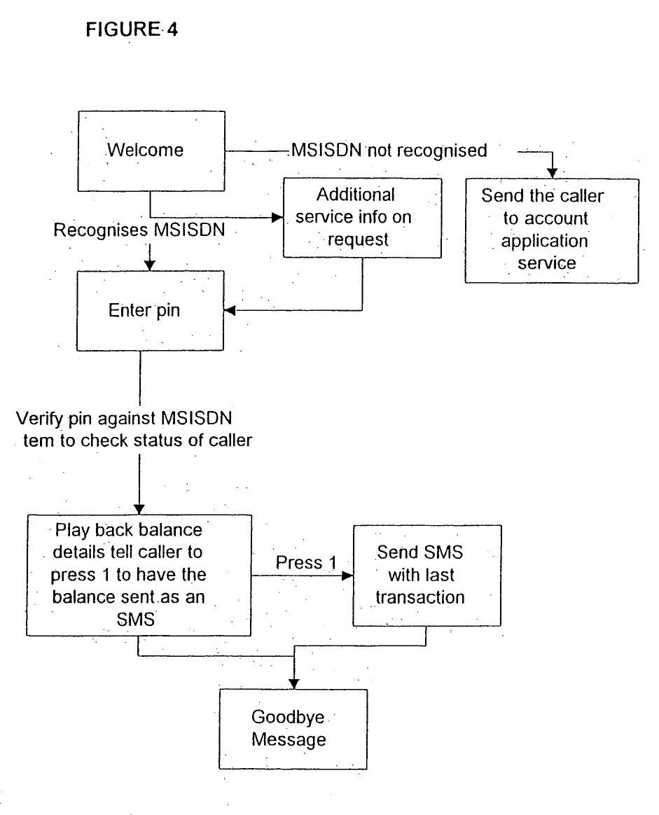

The flowchart of FIG. 4 illustrates the operation of the Call Balance Service. This service allows a client to receive their bank balance on request, via the IVR interface. The client is given the option of receiving the bank balance in an audible format generated by the IVR interface, or as an SMS format message sent to the mobile telephone of the client. In the prototype system, the balance is, played back to the caller via the IVR system, and the caller is then given a further option to have the balance transmitted to their mobile telephone as an SMS.

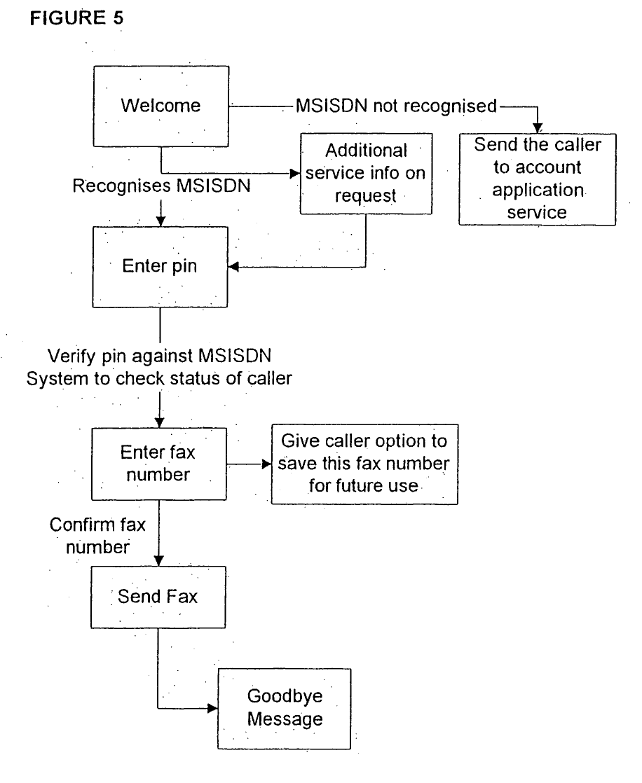

The operation of the Pull Statement service is illustrated in the flowchart of FIG. 5. This service allows a client to enter a fax number so that a statement can be transmitted to that number in standard facsimile format. The entered fax number can be saved for future use if desired.

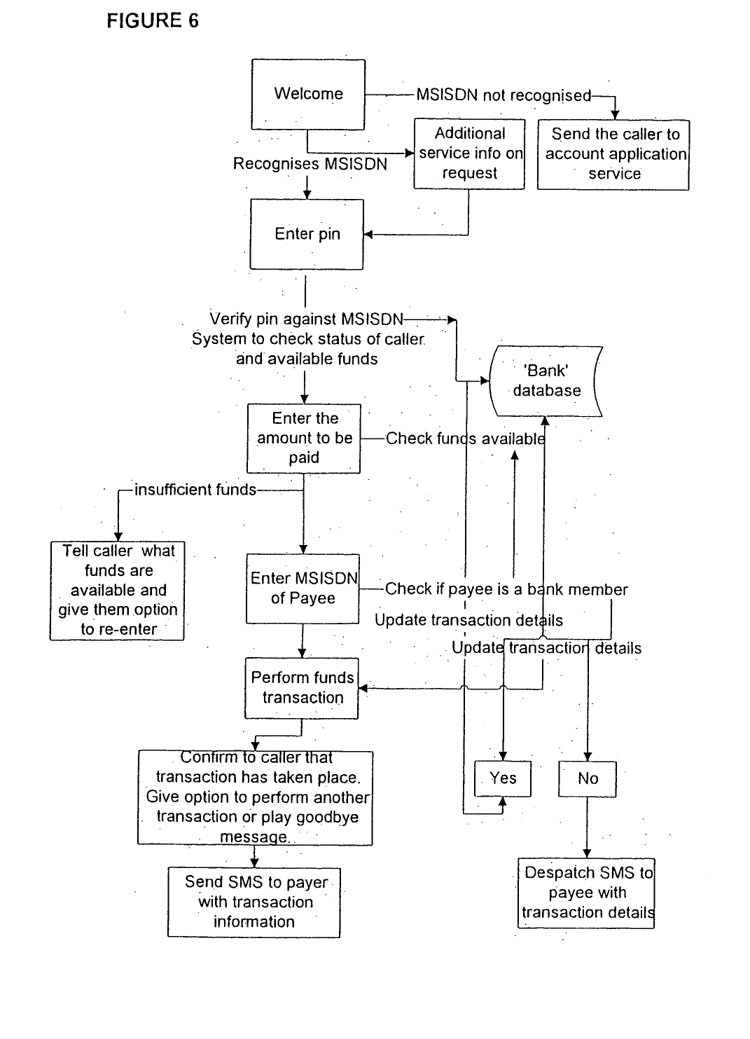

The functioning of the call payment service of the invention is shown in the flowchart of FIG. 6. This service allows a first client who is registered with the banking service to make a payment to a second client who is also registered with the banking service by merely entering the mobile telephone number of the second client.

As for the previously described services, the first client or payer calls the call centre, is identified by CLI and verifies his/her identity by entering a PIN. The first client then enters the amount that they wish to pay, following which the system queries the bank account database to ensure that the first client has sufficient funds available for the transaction. Once this has been verified, the first client enters the mobile telephone number corresponding to the bank account number of the second client or payee. The necessary database entries are made to reflect the debiting of the first client's account and the crediting of the second client's account, and SMS messages confirming the transaction are sent to both the payer and the payee, to their respective mobile telephones.

Even where the payee is not a registered client of the banking service, it is possible for a client of the banking service to make a payment by stipulating the mobile telephone number of that payee to the system. The payment is then kept in a holding account, allocated to the payee, and an SMS message is sent to the mobile telephone number specified by the payer, informing the payee of the payment. The SMS preferably contains a help line number which can be contacted by the payee, utilising his/her mobile telephone, to register with the banking service and open an account. Alternatively, the payee can arrange to withdraw the funds or have them transferred to an account at another bank.

FIG. 7 shows the account application process which must be followed by a new client. A new client can complete an application form and take it to an office of the banking service for processing in a conventional manner. In addition, the prospective client can contact the call centre and access a number of options via the IVR interface. These options include having an application form faxed to them at a specified number, leaving a number on which to be contacted by a consultant, or requesting to be called back on the number from which they dialed, minimising the number of digits required to be entered.

In order to maintain an adequate record of transactions carried out via the banking service, the following information is logged for each transaction, as applicable:
Value Added Service Provider ID
MSISDN of payee
SMS ID
Time SMS arrived at SMS engine
Time call was made to service
Type of request
Transaction from and to
Amount transacted
SMS content
MSISDN SMS sent to

The IVR application used to implement the prototype banking service of the invention consists of various components including state tables, prompts, voice directories and custom servers and was developed using the IBM Direct Talk 2.2 platform.

The following state tables, prompts, voice directories and custom servers are utilised in the prototype system:

State Tables:

INT_Orbit:

This is the calling state table and offers the caller the opportunity to choose the sub-service they would like to access. It then calls the appropriate state table.

INT_Orb_Dbal:

This state table handles the functionality for the Delta Balance sub-service. When routed to this'state table the caller's MSISDN is verified against all registered clients in the database. If the caller is found to be a registered client he/she is prompted to enter a PIN number for verification. A caller who is not a registered client is routed to the New Application sub-service. The PIN number is then verified against the PIN number and MSISDN in the database. If the PIN is verified successfully the client is allowed to continue. If the PIN and MSISDN combination do not match the PIN and MSISDN in the database the caller is asked to re-enter the PIN number. If the caller enters the wrong PIN three times, the caller is dropped from the line. Once the client has been verified he/she can then configure the Delta Balance service. The configuration is stored in the database from where it is polled by a backend Java application which sends the client his/her balance via SMS.

INT_Orb_Cbal:

This state table handles the functionality for the Call balance sub-service. When routed to this state table the caller's MSISbN is verified against all registered clients in the database. If the caller is found to be a registered client he/she is prompted to enter his/her PIN number for verification. If the caller is not a registered client, he/she is routed to the New Application sub-service. The PIN number is then verified against the PIN number and MSISDN in the database. If the PIN is, verified successfully the client is allowed to continue. If the PIN and MSISDN combination does not match the PIN and MSISDN in the database the caller is asked to re-enter the PIN number. If the caller enters the wrong PIN the times, the caller is dropped from the line. Once the client has been verified his/her current account balance is dictated to him/her by the IVR line. The client then also has an option of receiving his/her account balance via SMS.

INT_Orb_State:

This state table handles the functionality for the Statement faxback sub-service which can only be accessed from a fax/phone. When routed to this state table the caller's MSISDN is verified against all registered clients in the database. If the caller is found to be a registered client he/she is prompted to enter his/her PIN number for verification. If the caller is not a registered client, the caller is routed to the New Application sub-service. The PIN number is then verified against the PIN number and MSISDN in the database. If the PIN is verified successfully the client is allowed to continue. If the PIN and MSISDN combination does not match the PIN and MSISDN in the database the caller is asked to re-enter the PIN number. If the caller enters the wrong PIN three times, the caller is dropped from the line. Once the client has been verified he/she is asked to press the start button on his/her fax/phone machine and the current monthly statement will be faxed to the number of that machine.

INT_Orb_Pay:

This state table handles the functionality for the Payment sub-service. When routed to this state table the caller's MSISDN is verified against all registered clients in the database. If the caller is found to be a registered client he/she is prompted to enter his/her PIN number for verification. If the caller is not a registered client, the caller is routed to the New Application sub-service. The PIN number is then verified against the PIN number and MSISDN in the database. If the PIN is verified successfully the client is allowed to continue. If the PIN and MSISDN combination does not match the PIN and MSISDN in the database the caller is asked to re-enter the PIN number. If the caller enters the wrong PIN three times, the caller is dropped from the line. Once the client has been verified his/her current balance is checked and played back to him/her. The client is then asked to enter the amount he/she would like to pay. The system then checks if there are enough funds to make the payment. If the client does not have enough funds available, he/she is asked to enter a smaller amount, or has the option to exit the system. If enough funds are available the client is asked to enter the MSISDN he/she would like to pay the money to. The client is then asked to confirm the amount to be paid and the payee's MSISDN. On confirmation the transaction is entered into the database and once an acknowledgement has been received from the database the client (payer) is told that the transaction has been completed successfully. The client is then given the option of making another payment or exiting the system.

The transaction entered into the database activates a trigger which sends the request for the transfer of funds to the payee. At the same time two SMS's are generated which are sent to the payer client and the payee confirming the transaction and containing the unique transaction reference number.

INT_Orb_Appl:

This state table handles the functionality for the New Account Application sub-service which can only be accessed from a fax/phone. When routed to this state table the caller's MSISDN is checked to make sure he/she is not calling from a cellular phone. Once the client has been verified he/she has the options of either receiving a faxed application form or to leave his/her details in a voicemail box so that he/she can be contacted by a helpdesk operator.

Prompts:

INT_Orbit:

This prompt directory contains various prompts that handle the playback of voice segments for numbers, currency and voice.

Voice Directories:

INT_Orbit:

This voice directory contains all generic voice segments like the welcome segment, technical difficulty segment etc.

INT_Orbit_Gnrl:

This voice directory contains all the possible digit and number segments that are played, on the line. Amounts of up to one hundred thousand billion can be played back.

Custom Servers:

INT_TibSocket:

This custom server handles all the database calls for this application. It interfaces between the dt6 voice platform and the database.

The database constructed to manage the system of the invention was implemented as a Sybase database and contains the relevant tables, stored procedures, functions and figures required to implement the system.

The following features can be added to the basic system described above in order to enhance its functionality and facilitate interaction with existing banking systems.

Debit Pull Service

This service allows a client to “debit pull” funds from their conventional bank account into their account in the system of the invention. Details of all existing bank accounts (or similar accounts) that the client may wish to interact with (and a direct debit mandate) must be supplied during the above described account application process, or can be provided at a later stage via a web interface or using call centre assistance.

Once the client has selected the option to credit his/her account on the system of the invention with funds from another, conventional account, he/she will be asked to enter their PIN number. The IVR system recognises the client and plays back the list of accounts they are able to debit from. The client must select the account he/she wishes to debit and enter the amount to be debited. The client is asked to confirm the transaction and is told in accordance with banking standards that it may take 48 hours to complete.

The client may select an option to be informed by SMS when the funds are received in their account.

Credit Push Service

In the same way that clients can transfer funds from an existing “external” bank account they may also transfer funds from their account in the system of the invention to such a conventional account. The client is asked to select the account they wish to transfer to, to enter the amount they would like to transfer into the selected account, and to confirm the requested transaction.

Should the transaction not be effected immediately the client can asked to be informed by SMS when the funds leave their account in the system of the invention.

Payment of Beneficiaries

The banking system of the invention can also be used for the payment of third party beneficiaries that have been set up by the client. The system will accommodate once-off payments, recurring payments and scheduled payments to these beneficiaries. The process of setting up such beneficiaries is similar to that required for the debit pull and credit push services described above, and is therefore not described in greater detail.

In all cases the client can choose to be provided via SMS with a confirmation of the transaction taking place.

1. A method of operating a banking service, the method comprising:
registering a plurality of clients with the banking service, including recording a unique number associated with a mobile telephone of each client;
allocating an account number to each client which comprises at least a part of said unique number;
receiving, from time to time, calls from a client via the mobile telephone;
verifying the client's identity from data transmitted from the mobile telephone corresponding to said unique number; and
conducting at least one banking transaction relating to the account corresponding to said unique number.

2. A method according to claim 1 wherein the account number allocated to each client corresponds to the unique network number of the mobile telephone.

3. A method according to claim 2 wherein the account number corresponds exactly to the Mobile Station Integrated Services Digital Network (MSISDN) number of the mobile telephone.

4. A method according to claim 1 further comprising providing an Interactive Voice Response (IVR) interface responsive to selective data transmissions from the mobile telephone to select and configure at least one of a plurality of banking service options.

5. A method according to claim 4 wherein the plurality of banking service options comprises a bank balance service, a bank statement service and a payment service.

6. A method according to claim 5 wherein the bank balance service comprises transmitting bank balance data to the client at intervals specified previously by the client, or on request.

7. A method according to claim 6 wherein the bank balance data is transmitted in SMS format to the mobile telephone of the client.

8. A method according to claim 6 wherein the bank balance data is transmitted to the mobile telephone of the client in an audible format.

9. A method according to claim 5 wherein the bank statement service comprises transmitting statement data to a facsimile number stipulated by the client in a request made by the client to the IVR interface.

10. A method according to claim 5 wherein the payment service comprises the steps of receiving a payment instruction from a payer who is a registered client of the banking service, the payment request comprising the amount to be paid and a unique network number of a mobile telephone of the payee, and transferring funds from the payer's account to the payee's account.

11. A method according to claim 10 wherein both the payer and the payee are registered clients of the banking service, each having an account number which corresponds exactly to the unique MSISDN number of their respective mobile telephones.

12. A method according to claim 5 wherein the payment service comprises the steps of recording at least one account number of an external account held with a conventional banking service, and receiving an instruction from a registered client of the banking service to transfer funds to or from said external accounts, from or to the registered client's account.

13. A method according to claim 10 further comprising transmitting payment confirmation data to the mobile telephones of the payer and the payee.

14. A method according to claim 13 wherein the payment confirmation data is transmitted to SMS format.

15. A system for operating a banking service, the system comprising:
a database for storing client registration data of a plurality of clients including a unique number associated with a mobile telephone of each client and a bank account number which comprises at least a part of said unique number;
a call center for receiving calls from clients via their mobile telephones, for verifying a client's identity from data transmitted from the client's mobile telephone corresponding to said unique number, and for enabling the conducting of at least one banking transaction relating to the account corresponding to said unique number; and
a bank account database for storing details of balances and transactions in each client's account.

16. A system according to claim 15 wherein the account number allocated to each client corresponds to the unique network number of the mobile telephone.

17. A system according to claim 16 wherein the account number corresponds exactly to the Mobile Station Integrated Services Digital Network (MSISDN) number of the mobile telephone.

18. A system according to claim 15 wherein the call center is an Interactive Voice Response (IVR) interface responsive to selective data transmissions from the mobile telephone to select and configure at least one of a plurality of banking service options.

19. A system according to claim 15 including Short Message Service Center (SMS-C) arranged to serve as a gateway between the mobile telephones of clients and the system and to transmit bank balance data and payment confirmation data from the system to the mobile telephones of clients.

20. A system according to claim 15 wherein the bank account database is a secure database operated by a value added service provider in conjunction with a cellular network operator.
